(19) United States
(12) Patent Application Publication
(10) Pub. No.: US 2011/0291677 A1
(43) Pub. Date: Dec. 1, 2011

(54) METHOD AND APPARATUS FOR DEFECT DETECTION

(75) Inventors: Daniel-Constantin Bodea, Iasi (RO); Patrick Hampe, Bangkok (TH)

(73) Assignee: TGT ENTERPRISES LTD., HONG kONG (CN)

(21) Appl. No.: 13/061,914

(22) PCT Filed: Sep. 2, 2009
(86) PCT No.: PCT/CN09/73687

§ 371 Date: Jul. 21, 2011

(30) Foreign Application Priority Data
Sep. 2, 2008 (SG) 2008-06868-6

(51) Int. Cl. G01N 27/20

(52) U.S. Cl. 324/693

(57) ABSTRACT

A system for detecting a defect in a membranous article (20) comprising: an emitter probe (10) connected to an electrical supply (14), said probe (10) insertable into a cavity of said article (20); a sensor (15) for receiving an electrical discharge from said probe (10); a conveyor system for bringing the probe and sensor into mutual proximity; a processor for measuring the potential difference between the probe and sensor, said processor capable of detecting a defect based upon said measurement.

### FIELD OF THE INVENTION

The invention relates to the detection of defects including tears and pinholes, and in particular such defects in membranous articles, such as gloves used for medical purposes and condoms.

### BACKGROUND OF THE INVENTION

Membranous articles are typically made from latex, synthetic rubber, or other visco-elastic polymer. Such membranous articles include surgical gloves or other gloves used for medical purposes, and condoms. Such gloves provide barrier protection for healthcare professionals against micro-organisms and blood borne viruses including hepatitis B. They also provide barrier protection against chemicals that are routinely used in medical procedures. As a consequence, the routine wearing of gloves are an essential requirement for operator and patient safety.

Glove manufacturers assess gloves for pre-existing pinhole defects using the European Standard EN 455-125 or the ASTM standards. These documents state that the water tightness test, in which the glove is filled with one litre of water and assessed for leaks after two minutes, may be replaced by any test that is validated against it. The detection of pre-existing pinhole defects has previously been assessed using these tests or similar, such as a water inflation technique, or an air inflation/water submersion technique or both methods.

In each case, these methods have the inconvenience of cost, residence time and other issues that make the use of such methods uneconomic for continuous or batch type processes for low cost high volume articles. In particular a residence time of two minutes in order to meet the European and ASTM standards precludes these tests from a continuous or batch process. For high volume testing, a matter of seconds for a test result would be required. As a consequence, testing according to these standards relies on a statistical approach whereby a sample is taken from a manufactured lot with the test results for the sample extrapolated to represent the entire manufactured lot. Whilst a statistical approach is well established, there remains some doubt of the appropriateness of this approach given that an aberrant result for a non tested glove may have severe consequences if a defect were to leave too and infected health worker.

Further, if the concept of recycling of membranous gloves were investigated, a statistical approach would have less veracity as no such relationship between the sample and the lot exists.

A common method for determining whether a glove is suitable for medical use is the Water Test.

The Water Test, also known as the leak test, consists of filling a glove with a large amount of water (about 1 litre) and see if there are any leaks. If there are holes, then small drops of water will leak through the material and, as a result, the glove will be considered to have a defect such as a pin hole.

The method is slow, and not very suitable for high volume batch processing, as it takes a few seconds to fill the glove (about 10 seconds, so the glove won't be broken by the water jet), more time for the glove to leak, another few seconds to empty the glove and so on. In the end, after about a minute, the decision can be made but it will result also in a wet glove.

Besides the large amount of time it takes for the decision to be made, it is close to impossible to automate the whole process. This test is usually a statistical one and the error margins are somewhat large.

It is, therefore, an object of the present invention to provide a means of detecting pinholes and/or defects that is more broadly applicable and also, can be arranged to form part of a sequential process.

### STATEMENT OF INVENTION

In a first aspect, the invention provides a system for detecting a defect in a membranous article comprising; an emitter probe connected to an electrical supply, said probe insertable into a cavity of said article; a sensor for receiving an electrical discharge from said probe; a conveyor system for bringing the probe and sensor into mutual proximity; a processor for measuring the potential difference between the probe and sensor, said processor capable of detecting a defect based upon said measurement.

In a second aspect, the invention provides a method for detecting a defect in a membranous article comprising the steps of: inserting an emitter probe into a cavity of said article, said emitter probe connected to an electrical supply; bringing said probe into mutual proximity with a sensor; connecting the probe to an electrical supply; measuring the potential difference between the probe and sensor using a processor; detecting a defect based upon said measurement.

Accordingly, the system according to the present invention provides a broad based arrangement for detecting defects tears or pinholes, which forms part of a processing step for a “production line” or a reconditioning gloves application.

In particular, articles such as examination or surgical gloves may be particularly applicable for the system according to the present invention as would condoms. Gloves of synthetic, rubber and/or latex polymers are, according to the present invention, suitable therefore avoid damage to said gloves and so supporting the economical testing of these gloves wherever it needs to occur: on line mass manufacturing and or during a (re)processing activity.

### BRIEF DESCRIPTION OF DRAWING

It will be convenient to further describe the present invention with respect to the accompanying drawings that illustrate one possible arrangements of the invention that is valid out of the manufacturing line. Other arrangements of the invention are possible and consequently the particularity of the accompanying drawings is not to be understood as superseding the generality of the preceding description of the invention.

FIG. 1 is a schematic view of a system according to one embodiment of the present invention;

FIG. 2A is a cross sectional view of a glove being tested in accordance with one embodiment of the present invention;

FIG. 2B is a cross sectional view of a glove being tested in accordance with a further embodiment of the present invention;

FIG. 2C is a cross sectional view of a condom being tested in accordance with a still further embodiment of the present invention;

FIG. 3 is a graphical representation of a characteristic received from a test according to one embodiment of the present invention

FIG. 4A is a schematic view of a resistor model of a test arrangement according to the present invention;

FIG. 4B is a schematic view of a further resistor model of a test arrangement according to the present invention;

FIG. 5 is a graphical view of a potential difference model for a test according to the present invention;

FIG. 6 is a schematic view of a further resistor model of a test arrangement according to the present invention;

FIG. 7 is a graphical view of an output result model for a test arrangement according to the present invention;

FIG. 8 is a graphical view of the results of an experiment conducted according to the present invention;

FIG. 9 is table of results of the experiment as graphed in FIG. 8.

### DETAILED DESCRIPTION

The invention is directed to a method and system based on the usage of high voltage which produces an intense electric field around a membranous article, for the purpose of detecting electrical charge leakages of the membranous article.

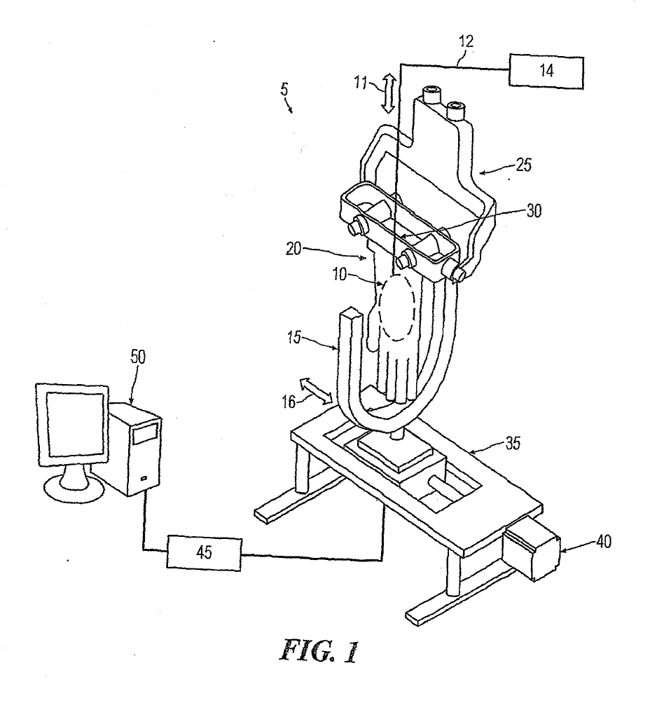

FIG. 1 shows a schematic view of one embodiment of the present invention. Here a High Voltage generator 14 is supplying high electric potential to an emitter probe 10 via a cable 12 which by a conveyor (not shown) an up/down motion 11 is introduced inside the glove to be tested. The glove carrier 30 brings the glove 20 in to be tested position. Then, the emitter probe 10 is placed by the conveyor down into position. Next the U-shape sensor 15 commences a horizontal movement 16 to scan the entire surface of the glove 20 by a Sensor Horizontal Slider 35. Said slider 35 is operated by a motor 40, which may be under manual or automated control.

During the scan an Analog-Digital Converter 45 converts the electric potential difference (Volts) into numeric data for PC-based analyzer software 50. The output of the PC-based analyzer software provides an easy logical data PASS/FAIL about the glove tested. The time required for scan is in range of few ms to 3 seconds. The precise time will be a function of, but not limited to, the type of glove, the economics of the output voltage and equipment size. In designing the system, the skilled person may consult the literature or conduct basic iterative tests to determine such parameters, which are not, in them, a limitation of the invention.

The high voltage generator 14 used in the present invention may have to provide a minimum 20 KV output with a varying frequencies of the impulses from 400 Hz up to 4 KHz.

The emitter probes 10 have to be made from a non-corrosive conductive material with a very smooth and round surface, avoiding sharp edges. The dimensions are related to the application and glove dimensions and type.

The Glove carrier 30 is a mechanism designed according with the specific requirements of the application, to bring and remove the glove in/out of the testing area. For example, a glove carrier as shown in PCT/SG2007/000076 shows a carrier that may be applicable to this process, the contents of which are incorporated herein. Thus the method and system according to the present invention is adaptable to a batch or continuous process given its applicability to a carrier arrangement and the speed by which the tests can be conducted and results obtained.

In this embodiment, the U-shape sensor 15 is made from a 60 μm diameter or less corona wire gold plated type. The wire is placed in a plastic channel to obtain a narrow area of instant readings. The dimensions and the curvature of the sensor are strict related to the application and the glove material and type. An alternative arrangement might have the sensor arranged to move vertically along a vertical conveyor. In this arrangement a circular sensor may also be used with the glove being lowered within the annular void of such a circular sensor. Other arrangements may be possible given that the sensor must provide coverage around a substantial portion of the periphery of the emitter probe whilst within the glove.

The Sensor Horizontal Slider may be made from plastic components to avoid unwanted discharges with the emitter probe 10 and create electrical noise for the U-shape sensor 15. The horizontal movement is obtained with a stepper motor which is able to provide an easy to adjust and constant speed in front and back.

The Analog Digital converters 45 have to be able to convert electrical potential, Volts in numeric data and have a less than 133 ms sampling rate, in order to achieve an ideal arrangement for a batch or continuous process.

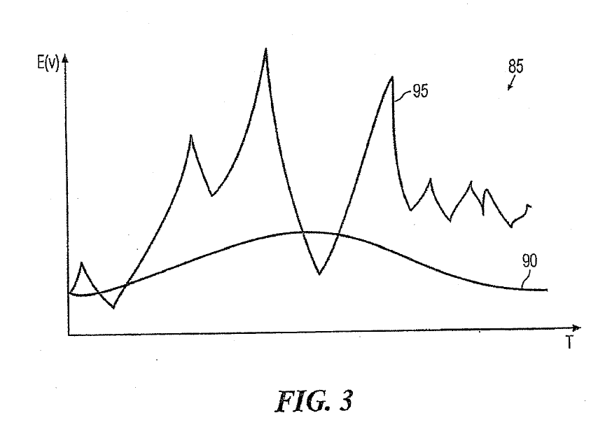

The PC-based analyzer software 50, have an algorithm to find maximum, sums or averages of values supplied by the AD converter 45, and return a PASS/FAIL result. For instance FIG. 3 shows a graphical representation of the type of information received from the AD converter 45 and processed by the PC based analyzer software 50. A glove 20 being tested by the system 5 and having no defects may show a smooth continuous characteristic 90 with a possibly marginal maximum indicating a continuous detection of a small potential difference. In the case of a defect in the tested glove, the graphical representation shows markedly discontinuous characteristic 95 which would be expected from a defect producing a widely varying potential difference during the testing operation. The analyzer 50 may automatically detect the presence of a discontinuous characteristic 95 as compared to a standard characteristic 90. The means by which the characteristic is identified may be identifying a maximum potential difference or a potential difference exceeding a known predetermined limit. Alternatively the analyzer 50 may identify discontinuities within the characteristic itself. The complexity of this analysis may vary between different propriety programs or software developed specifically for the purpose. Still further, the analyzer 50 may be sufficiently complex to identify the nature of the defect based upon the discontinuous characteristic 95 either from the level of maximum potential difference or from the shape of the characteristic as to whether a full pinhole and the nature of the pinhole such as size etc which may produce similar characteristics.

The defects tears, pinholes detection method according to the present invention may provide any or all of the following advantages:
i. Fast method, less than 2 seconds for some applications;
ii. No contact between test apparatus and the glove, and so avoid cross contamination issues
iii. It doesn't require special controlled atmosphere or the existence of other neutral gases;
iv. Do the detection from high distance from the material such as around 9 cm.

From another application like a gloves manufacturing plant pinhole testing area, the emitter probes consists of the moving glove mold itself than has been rendered electric conductive, then the U-shaped sensor may be replaced by a fix array of similar sensors. This set up decrease the speed of detecting defects tears or pinholes to milliseconds.

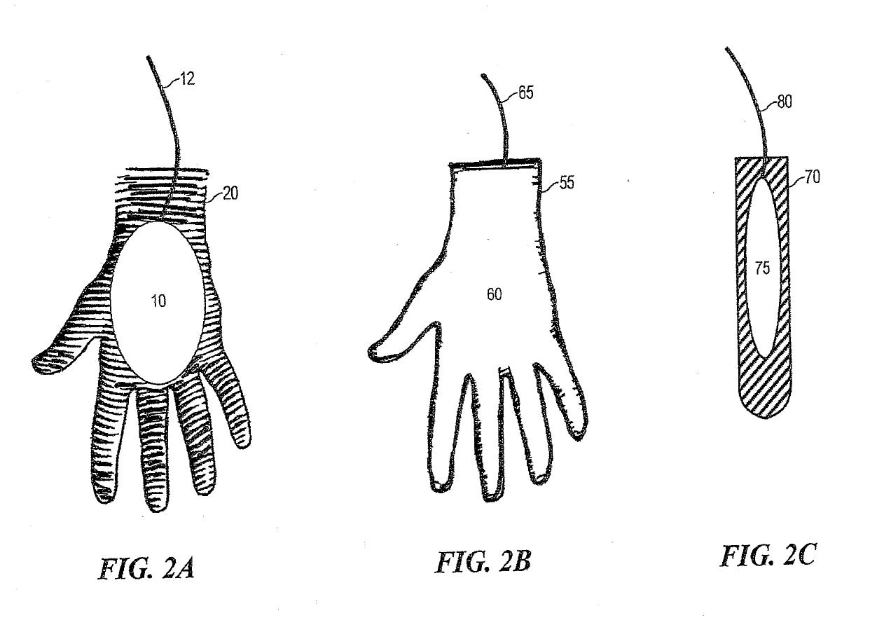

The system and method may have wide application as demonstrated by FIGS. 2A, 2B and 2C. FIG. 2A shows a test arrangement similar to that shown in FIG. 1 whereby a glove 20 has inserted therein an emitter probe 10. The emitter probe 10 is attached to a cable 12 providing communication with the high voltage generator. It will be noted that in this end in all applications the emitter probe 10 is fully within the glove so as to avoid any spurious results from the emitter having direct access to the sensor. Whilst this arrangement is suitable for many applications, it has broad applicability for both testing recycled gloves and so being positioned within a recycling process or conveyor. It may also be used for the testing of a new glove and so being part of the formation process just prior to packaging.

FIG. 2B shows a different embodiment to that of FIG. 2A. Here the testing and formation process for a new glove 55 has been advantageously combined. The emitter probe 60 in this embodiment is shaped like the glove and in fact may be formed within the glove mold so as to combine the emitter probe and the glove mold. In this case glove molds can often be of a ceramic material which is generally an insulator. Thus to combine the emitter probe and glove mold the ceramic may be doped with conductive particles. Still further, portions within the glove mold 60 may have an array of metal surfaces distributed around the outside surface of the mold 60 all connected by a core so as to provide the emitter probe function.

As discussed the system and method according to the present invention is applicable to the testing of membranous articles. Whilst gloves for medical purposes have direct applicability to the invention, other such membranous articles may also be tested. FIG. 2C shows a condom 70 having an elongate emitter probe 75 inserted therein whilst maintaining communication with the high voltage generator through a cable 80. Thus the testing of the condom 70 may fall within the scope of the present invention by adapting the probe and processes.

As the applications of FIGS. 2B and 2C are directed to new manufacture, in these cases it may appropriate to have fixed control of the sensor. In this case for new manufacture of the membranous article, the sensor may remain static whilst a conveyor moves the membranous article through the sensor. In so doing, the continuous process for the manufacture of the membranous article may avoid stopping the progress of the article by passing through the sensor as part of the normal manufacturing process. The speed by which the test is undertaken may vary the width of the sensor such that if the manufacturing process is of a speed such that the test length is extended, then the sensor width may be increased so as to ensure the emitter probe remains within the sensor range for sufficient time in which to conduct the tests. As the analyzer step is also very fast, the article may be discarded shortly after testing so as to avoid the article undergoing unnecessary processing downstream from the defect test.

In an alternative embodiment, one embodiment of the present invention uses the force and penetration of a strong electric field to detect whether or not there are any holes in the surface of the latex glove. In this embodiment, the invention comprises the following components:

A Central Unit—Powering unit. It is used to convert the energy from the power supply into the electric field the apparatus uses. It has multiple buttons used to activate and control the apparatus and 4 main connections, situated on the back panel:

The Main Electrical Plate: oval shape metal plate made of stainless steel. It connects to the Central Unit using a power cable that goes to the HV Output. The position of the Electrical Plate will vary as it will have to get in and out of the inflated latex gloves. The Main Electrical Plate represents the first electrode of the ensemble.

The Sliding Sensor: A “U” shaped sensor that slides from one end of the glove to the other used to collect data. The sensor has two connections:

As previously stated, the sensor is connected to the Reference Output, through a Contrast Resistor.

The Sliding Sensor is directly connected to a Data Acquisition System/A to D converter used to collect and format the data for the decision process.

The Sensor comprises a very thin “Corona” type wire and represents the second electrode.

The U shape sensor is driven from one end of the glove to the other end by a step by step motor.

The generator, as stated, converts the energy from the power supply into the energy of a powerful electric field. Although it does not transform the electrical energy into a different form of energy, it generates the necessary signal to achieve our goal (detecting pinholes).

Mainly, it creates a high potential difference between the two electrodes.

φ(x, y, z) (1)

Corresponding to this potential difference is the electrical field \vec{E} which can be calculated using Maxwell's Equations and a derived formula would be:

\vec{E}=∇φ(x, y, z) (2)

The electric field vector equals the gradient of the potential function. In order to understand the power of the electrical field, the equation for electrical field may be simplified by considering the following case. Assume that the potential generated by the generator is continuous and constant and the two electrodes are two infinite planar metal plates.

Equation (2) can be reduced to the following form:

$${E}^{} = \frac{{U}_{ab}}{{r}_{ab}} • \frac{{{r}_{ab}}^{}}{{r}_{ab}} \qquad ( 3 )$$

Where:

\vec{E}—is the electrical field intensity vector
U_{ab}—potential difference between point a and b

$$\frac{{{r}_{ab}}^{}}{{r}_{ab}}$$

—unitary direction vector from a to b, where a and b are two arbitrary points in space The usual voltage value is about tens of Kilovolts and the distance is less then 10 cm. That means that the created electric field is about 10 KV/cm, enough to create a discharge through the air but not enough to discharge through the latex.

To continue with the explanation of the phenomenon, we shall analyze to process of measuring the glove.

The high potential difference is applied between the two electrodes.

Electrons start moving from the Positive electrode (The Main Electrical Plate) to the Negative Electrode (the sensor) driven by the created electrical field. Each electron is moved by the Coulombian Force:

F̅=e·Ē (4)

Where:

e—electrical charge of the electron

Most of the electrons will have enough energy to reach the latex barrier but won't have enough to pass through it. However, a part of the electrical charge carriers will pass (will diffuse through the latex) and, attracted by the Negative Electrode will concentrate their directions to the sensor.

Reaching the Corona wire, the electrons will form a small electrical current, which passing through the contrast resistor will create a small potential difference (small as most of the energy was lost trying to pass through the latex).

Imagine now, that at a certain moment in time, the Corona wire and the Main Electrical Plate are perfectly centered on a pinhole. This time, most of the electrons won't have to consume their energy to pass through the latex and as a result, they will reach the sensor in greater number. The resulting current will be higher and also the potential difference on the contrast resistor.

U_{contrast}=I_{leakage}·R_{contrast} (5)

Therefore, the potential difference would be much higher if there would be a hole in the latex glove.

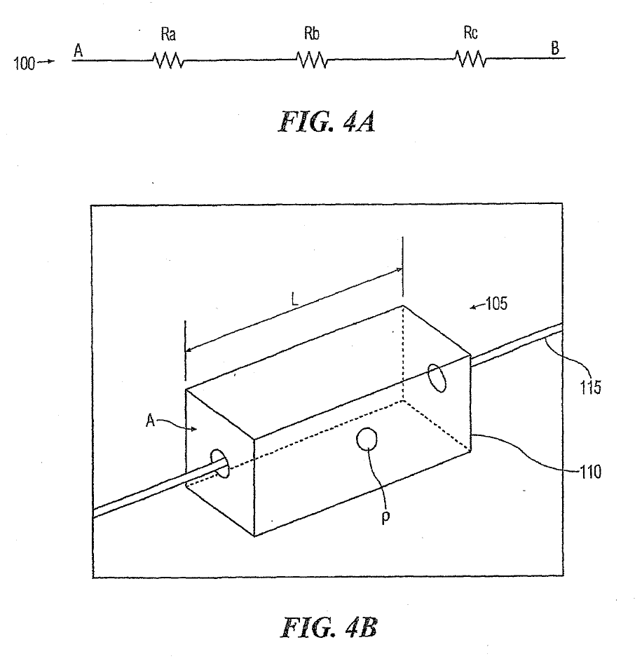

For a better understanding of the phenomenon, consider Ohm's law, and the models shown in FIGS. 4A and 4B.

$$R = \frac{U}{I} \qquad ( 6 )$$

Looking at the formula, it's easy to understand that, having a constant potential difference and different resistor, we will have different values for the current. The greater the resistor value the lesser the current intensity.

Between any two points, we can calculate a resistance, whose value can be approximated with the following formula:

$$R = ρ \cdot \frac{l}{A} \qquad ( 7 )$$

Where:

R—resistance value
ρ—resistivity of the material
l—length of the region
A—surface of the region

The approximation is valid for the following case 105. The material 110 has the same properties over all its axes 115 (in this case, resistivity/conductivity); the considered surface is constant over all the length of the region. However, if the hypotheses are not true, the resistance can be calculated as a group of elementary resistors 100 (can be calculated with (7) formula).

By this manner, we can calculate the resistance between the two electrodes. As the material varies (air, latex, air) we have to calculate it as a series of 3 elementary resistors.

If A represents the Anode Electrode and B the Cathode then the 3 resistors are:

Rₐ—resistance between the Anode and the glove
R_{b}—resistance between the two side of the gloves
R_{c}—resistance between the glove and the Cathode

The equivalent resistance between the Anode and Cathode will be calculated as follows:

R_{AB}=Rₐ+R_{b}+R_{c} (8)

In the measuring process, Rₐ and R_{c} always have the same values, the only value changing being R_{b}.

If there is a pinhole in the glove then the resistivity of air is lesser than the resistivity of latex:

ρₐᵢᵣ<<ρₗₐₜₑₓ (9)

And as a result:

R_{b}_{ₐᵢᵣ}<<R_{b}_{ₗₐₜₑₓ} (10)

Using relations (10) and (8), we can conclude:

R_{AB}_{_{goodglove}}>R_{AB}_{_{pinholeglove}} (11)

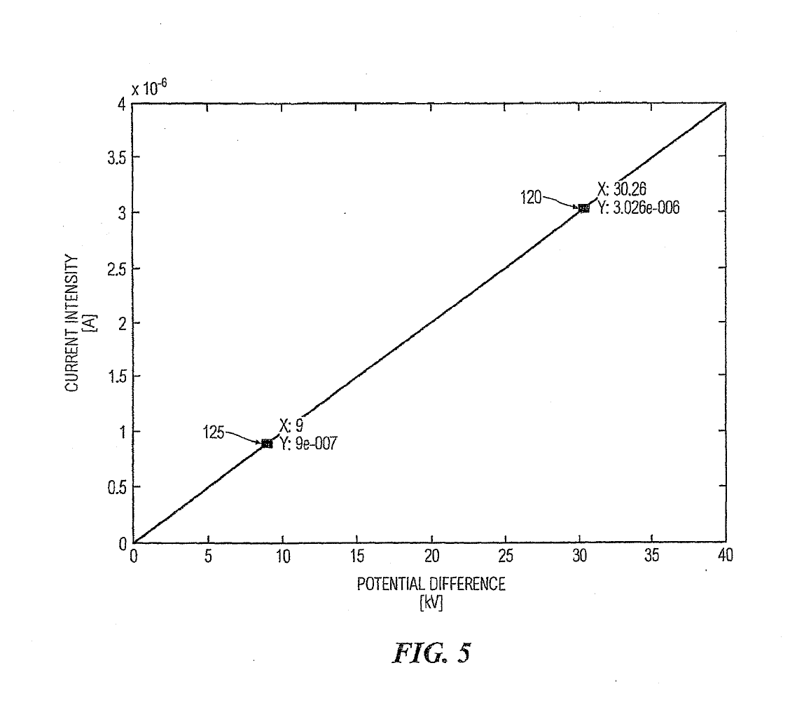

Now that we have cleared the resistor analogy, think of the potential difference between the Anode and Cathode. It is applied over the equivalent resistor. In case of a pinhole there will be a decrease in the resistor value, therefore an increase of the current. As shown in FIG. 5, the same potential difference will generate a greater current through a pinhole 120 compared with the glove 125.

As stated in the description, the sensor will glide and collect data from all the surface of the glove. This is done in order to have a clear electrical image of the glove. The movement of the sensor is continuous, yet the data cannot be collected continuously. It is done in a discrete way. For the entire glove, there are a number of N values of current intensity. The value we obtain is in fact a voltage; it results by the passing of the current through a contrast resistor.

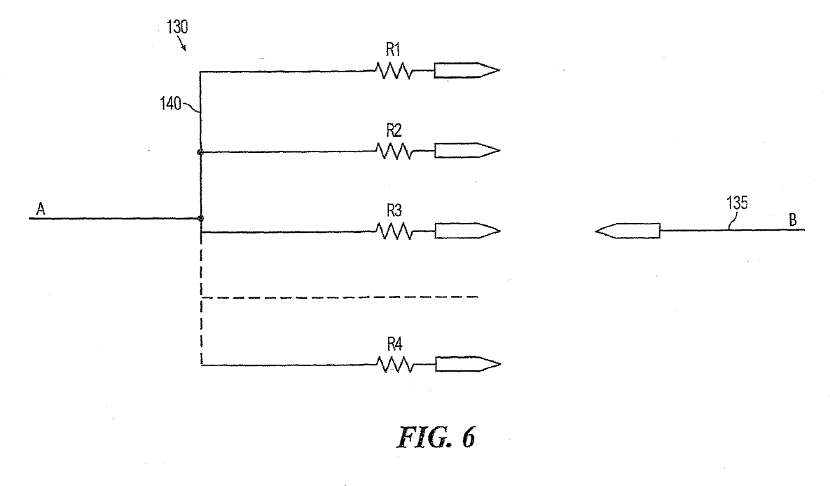

In this manner, we can consider the whole system as being a group 140 of N resistors as shown in FIG. 6, and each one is measured separately, one at a time, corresponding to each sampling.

In FIG. 6, A represents the Main Electrical Plate and B the sensor 135. B moves from R1 to R4 (or R_{N}).

The sampling is done using a Data Acquisition Card. The electrical image of the glove will be the N values that the DAQ reads and records.

Mostly, if all the approximations are true the decision process would be very simple (if the intensity value would be higher than the value for a good glove then we would have a pinhole).

But there are a number of factors that lead us to a more complex decision process:

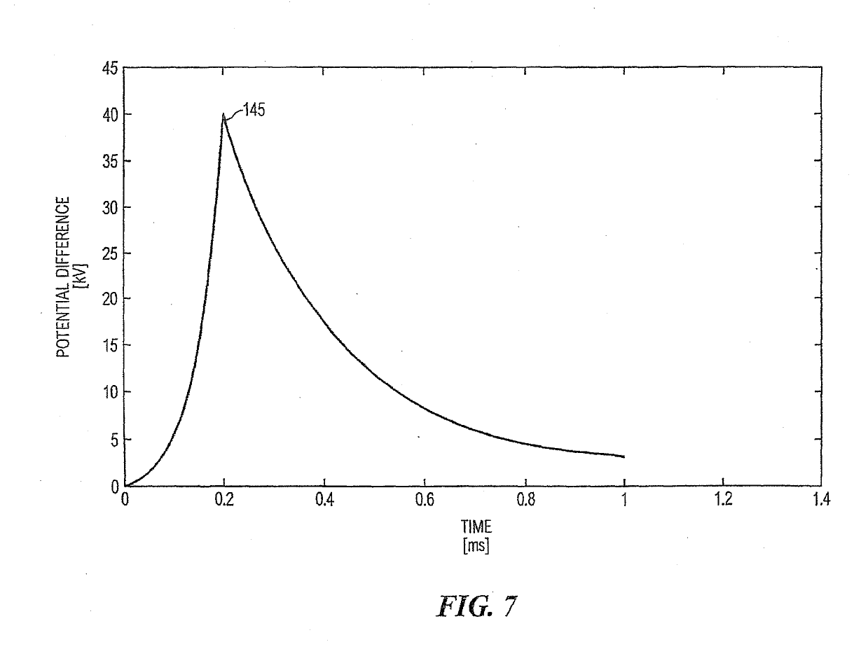

The potential difference is continuous but not constant. The signal applied to the Main Electrical Plate consists of many pulses 145 as shown in FIG. 7.
The glove doesn't have a uniform surface
The thickness of the glove is not uniform
The plate is not a perfect surface
The type of air is not constant

In order to decide whether a glove is punctured or not, the first step is to collect data. This means collecting a number of N values for each glove. After this is finished one of decision criteria can be applied.

### “Number of Violations Criteria”:

Before starting the decision process, a calibration using “good” gloves is run through the apparatus. Using the values for these gloves, the testing limits are calculated by the next method: for each measuring point, the maximum value of every good glove is considered to be a Threshold Value. This means evaluating the worst case Good Glove. After that the gloves are run through the apparatus. For each measuring point a higher value then the Threshold Value represents a violation. If a glove has more than a certain % of N (number of samples) then it has a pinhole, accordingly it is not a “good” glove and will be used for the calculation of the new limits

| P1 | P2 | P3 | P4 | P5 | FT1 | FI2 | FM3 | FR4 | FL5 |
|---|---|---|---|---|---|---|---|---|---|
| 31 | 34 | 33 | 31 | 37 | 26 | 24 | 31 | 28 | 26 |

### “Overall Value” Criteria:

Uses a number of calibration gloves also. It sums the values of all the samples of a glove and the maximum result is considered the limit for the Good Gloves.

Then, the same is done for the tested gloves, using a simple rule. A higher value means a pinhole.

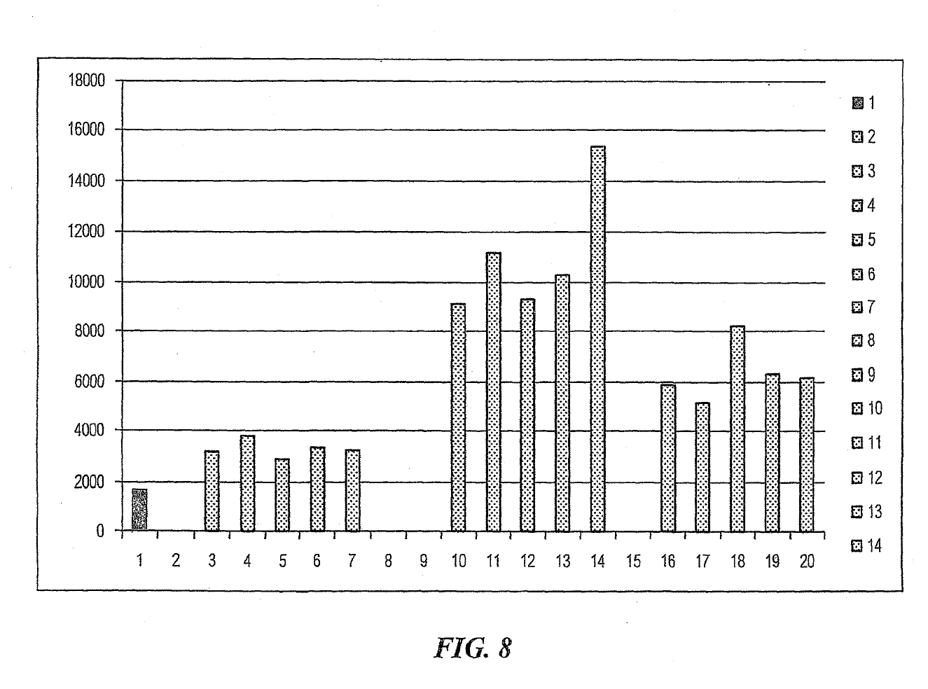

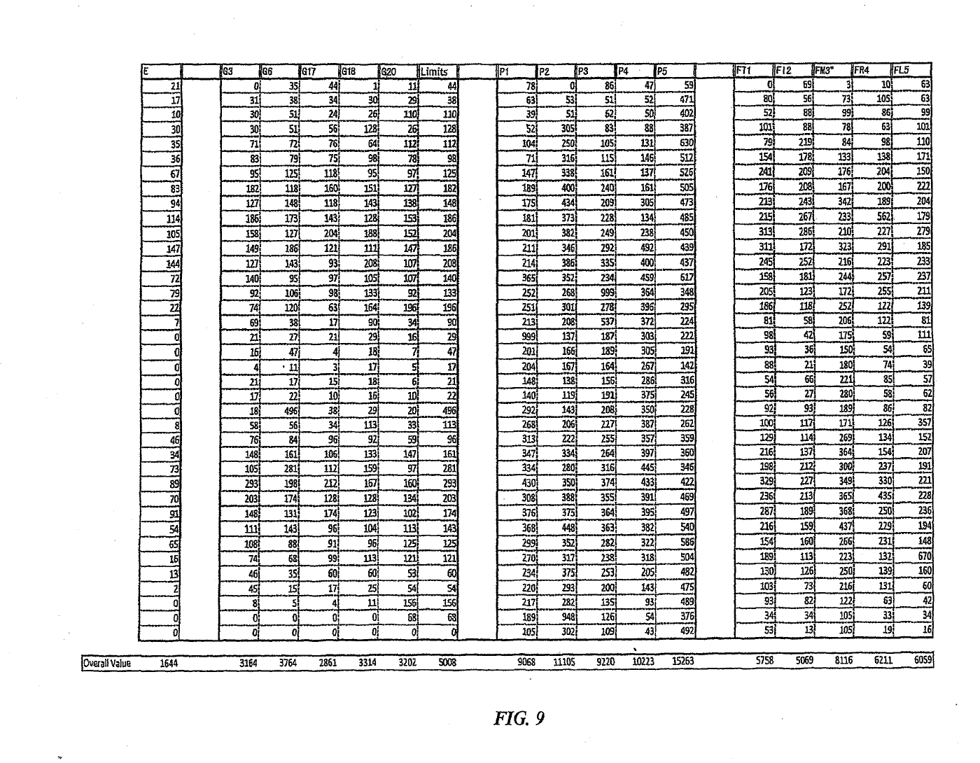

To show how the criteria are applied FIGS. 8 and 9 give tests results using a system according to the present invention. The test consists of passing 15 gloves through the machine. The used gloves were 5 good gloves (used for calibration), 5 gloves with a pinhole in the palm and 5 gloves with a pinhole in one of the fingers (5 gloves each different finger).

N, the number of samples, is 38, 19 samples for each sense. The sensor is moved by a motor, which makes a forward transition and 19 samples are collected, and after that a reverse transition and the other 19 samples are collected.

We also ran an empty test (with no glove in the apparatus). All the data is a table below and for better understanding, the used abbreviations are:

1 E—a test with no glove
G3, G6, G17, G18, G20—5 good gloves
Limits—are the limits for the “Number of violations” criteria; represent a measure of the “worst case” good glove
P1 to P5—5 gloves with a pinhole in a palm
FT1—glove with pinhole in the Thumb
FI2—glove with pinhole in the Index Finger
FM3—glove with pinhole in the Middle Finger
FR4—glove with pinhole in the Ring Finger
FL5—glove with pinhole in the Little Finger

### “Number of Violations” Criteria Result

For each glove with a pinhole the number of violations was calculated as follows: each was sampled separately and compared with the calculated limit (individually calculated for each and every sample number). One was assigned if the value was larger than the limit (meaning a violation) and zero if otherwise. These were summed up the number of violations for each glove and the results are in FIG. 9.

The number of violations for every good glove is 0 due to the manner of calculating the limits.

As shown in FIG. 9, for example, for the P1 glove, 31 one of the samples taken were larger than their corresponding limits and so on and so forth. As it can be observed it is very easy to decide whether the glove is punctured.

### “Overall Value” Criteria Results

For this method we summed all the 38 samples for each glove and plotted the results in the bar graph. Value 1 is the overall value for the empty measurement, Values 3 to 7 are the overall values for the 5 good gloves, Values 10 to 14 are the overall values for the 5 gloves with a pinhole in the palm and Values 16 to 20 are the overall values for the 5 gloves with the pinhole in the fingers.

1. A system for detecting a defect in a membranous article comprising:
an emitter probe connected to an electrical supply, said probe insertable into a cavity of said article;
a sensor for receiving an electrical discharge from said probe;
a conveyor system for bringing the probe and sensor into mutual proximity; and
a processor for measuring the potential difference between the probe and sensor, said processor capable of detecting a defect based upon said measurement.

2. The system according to claim 1 wherein the processor detects the defect by comparing the measured potential difference against a predetermined value.

3. The system according to claim 2 wherein said predetermined limit is taken as a potential difference between the probe and sensor with an intact membranous article there between.

4. The system according to claim 1 wherein the conveyor moves the probe relative to a static sensor.

5. The system according to claim 1 wherein the conveyor moves the sensor relative to a static probe.

6. The system according to claim 1 wherein the probe is metallic, having a conductive surface which is smooth and continuous and shaped so as to fit within said cavity without contacting the article directly.

7. The system according to claim 1 wherein the sensor is u-shaped and arranged so that the probe and sensor being in mutual proximity includes the probe positioning within the vertical arms of said U.

8. The system according to claim 1 wherein the membranous article includes gloves for medical purposes and condoms.

9. A method for detecting a defect in a membranous article comprising the steps of:
inserting an emitter probe into a cavity of said article, said emitter probe connected to an electrical supply;
bringing said probe into mutual proximity with a sensor;
connecting the probe to an electrical supply;
measuring the potential difference between the probe and sensor using a processor; and
detecting a defect based upon said measurement.
